(19) United States
(12) Patent Application Publication
(10) Pub. No.: US 2003/0069828 A1
(43) Pub. Date: Apr. 10, 2003

(54) System for and managing assets using priority tokens

(75) Inventors: Richard N. Blazey, Penfield, NY (US); Edward Covannon, Ontario, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 09/970,948

(22) Filed: Oct. 4, 2001

(51) Int. Cl. G06F 17/60

(52) U.S. Cl. 705/37

(57) ABSTRACT

The present invention is a system that allows users to bid on time slots of a video conferencing resource 10 using market orders and limit bid orders denominated in tokens of different values. The users are provided with a display 110 that shows the current bids and orders along with their account balance and allowed to place orders using tokens. The slots are allocated immediately when a market bid equals a market price and allocated to the highest bidder at an end of a bidding period for limit orders when a market order has not already captured the time slot. Winning order holders are informed about the allocation of the time slots with a confirmation display 200. The users allocated the time slots have a priority specified by the cost of the time slot in tokens and can be disabled from using the time slot after use has started. Users that are to be selectively disabled are determined by comparing user priority to a priority threshold, notifying the users who qualify and allowing them to upgrade their priority by paying more for the time slot in tokens that indicate priority.

### FIELD OF THE INVENTION

The present invention is directed to a system for allocating, negotiating over the allocation, scheduling and managing assets or resources, such as time slots on a network for conducting multimedia conferences and, more particularly, to one that uses tokens to negotiate over allocated resources, uses bidding with the tokens to allocate unallocated resources and uses the tokens representing continued access priority to manage or negotiate ongoing use of the resource when the resource degrades.

### DESCRIPTION OF THE RELATED ART

Resource allocation is a common problem for complicated, high demand systems, such as communication networks, and other finite resources. A first-come-first-served allocation method often leaves those who have a higher need but request the resource later without access to the resource. What is needed is a system that allocates the resource in a more efficient manner.

The decentralization of communication networks has made it difficult to manage network traffic. Centralized and homogenous networks provide administrators with many tools for the understanding and control of traffic on their networks and systems because of the unified nature of the software applications, operating systems and networking systems. It is more difficult to manage network traffic at the application layer in non-centralized, heterogeneous networks precisely because of the lack of an overall standard for applications and the lack of a single control point.

Prioritization schemes are valuable but do not provide the flexibility to respond to the unpredictable network loads by entirely shutting down an application and do not allow the clients to have a voice in setting the relative importance of their applications. Currently, users see prolonged delays or crashes without any clear idea of what is causing the problem. Management would preferably take the form of a system administrator compensating for unexpected network outages by being able to selectively remove traffic from the resource. A class of applications, or programs that are particularly prone to using network resources are those that use multimedia (images, video, sound) such as a video conferencing applications or image exchange software.

Desktop video conferencing is an increasingly popular way to connect workers from locations around the world who are working together on various projects. Many times, the desktop computers used for conferencing applications share the same local area network (LAN) with other key corporate services such as accounting, production control and e-mail. Because the “Streaming Video” often employed for conferencing takes up a significant amount of bandwidth on the LAN, corporate information services that operate the LAN often severely restrict or block conferencing to avoid the traffic jams that would result from unrestricted conference traffic sharing the network with other corporate functions. Conferencing then is typically relegated to specialized phone lines (e.g. ISDN lines) that results in limiting the convenience of the service and increasing the costs.

U.S. Pat. No. 5,978,463 issued Nov. 2, 1999 to Jurkevics et al. discloses an automated scheduling system that schedules audio conferences for an audio conferencing system. The scheduling of an audio conference results in the reservation of audio conferencing resources for a designated time frame. The automated scheduling system identifies what audio conferencing resources are available during the designated time frame and then chooses optimal ones of the audio conferencing resources to achieve load balancing and to prevent overflow of an audio conference between conferencing bridges. A scoring mechanism may be applied to identify the optimal audio conferencing resources for a given audio conference. The automated scheduling system is capable of operating in real-time so that a caller that requests the scheduling of an audio conference may receive confirmation and a phone number to call to participate in the audio conference during a single phone call. The automated scheduling system may also schedule a recurring series of audio conferences that occur at periodic intervals with common participants.

This approach schedules a time slot for a conference, but does not allow for priorities in the system, particularly for time varying priorities. For example, if certain times are more desirable, or have more traffic, or if certain users have a greater command on the resource, these prior art scheduling systems do not take this into account.

There is a need therefore for improved management and scheduling systems for scheduling the use of networked resources, particularly for resources such as multimedia conferencing.

### SUMMARY OF THE INVENTION

It is an aspect of the present invention to provide a system that improves the allocation of resources, such as network resources.

It is another aspect of the present invention to provide a system that improves management of resources, such as networked resources particularly for multimedia conferencing, when a system is degrading due to capacity constraints

The above aspects can be attained by a system that allows users to negotiate over access to and use of limited resources (such as uniformly allocated type resources like e-mail communication channel access and disk space, and on-demand type resources, such as video conferencing channels, that are allocated in other ways, such as FIFO) using tokens representing purchasing power. The system also provides for the allocation of demand type resources via allowing users to bid on use of the resources, such as time slots of a video conferencing resource or any other network/dependent resource, using market orders and limit bid orders valued in the tokens. The slots are allocated immediately when a market bid equals a market price set for the resource and allocated to the highest bidder at an end of a bidding period for limit orders when a market order has not already captured the resource. The users and associated applications allocated resource time slots have a priority and can be disabled from using the time slot after use has started by an administrator. User applications that are to be selectively disabled are determined by comparing user priority to a priority threshold, notifying the users who have applications that qualify for termination and allowing the user to upgrade the priority of the application when possible by paying a negotiated higher price using the tokens.

The invention provides for improved allocation, scheduling and ongoing management of limited resources, such as, but not limited to, video conferencing communication systems.

These together with other aspects and advantages which will be subsequently apparent, reside in the details of construction and operation as more fully hereinafter described and claimed, reference being had to the accompanying drawings forming a part hereof.

### BRIEF DESCRIPTION OF THE DRAWINGS

FIG. 1 depicts the network components of the present invention;

FIG. 2 shows the software components of the present invention;

FIG. 3 depicts the components of the management system in more detail;

FIG. 4 shows the flow of operations of the scheduling system;

FIGS. 5, 6, 7 and 8 depict screens used in the scheduling system;

FIGS. 9A and 9B show the flow of operations of the management system;

FIGS. 10A-10D illustrate displays used by an administrator in managing the resources of the network;

FIGS. 11A-11D depict displays user by a resource user in upgrading resource priority for an application;

FIG. 12 shows a priority maintenance screen; and

FIGS. 13 and 14 show the data structures used in the management program.

### DETAILED DESCRIPTION OF THE INVENTION

The present invention is directed to a means of system resource negotiation and allocation created by system administrators that can enable commerce in resources between users of the system. However, it should be emphasized that the reason for creating such a system is integral with the broadest problems in system resource administration not just for limited resources, such as video conferencing and e-mail. For example, the present invention is a system for negotiating over resources, such as video conferencing and e-mail.

System resources currently are purchased, allotted or allocated in a non-dynamic manner—that is, an agreement is made in the typical manner (often a contract) and modified during later review. For example, video conference channels may be allocated based on a first-come-first-served (FCFS) allocation method while e-mail may be allocated uniformly such that each individual is allocated the same channel bandwidth or channel speed. In a corporation, resources are typically budgeted depending on the importance of the individual to the company and possibly based on the importance of the department of the individual to the company. An individual may buy an account at an Internet service provider, such as AOL, for a certain amount of time, bandwidth or services at a certain base amount with exception clauses, which is another form of allocation. An individual wanting to have a web site hosted by a web site hosting system may buy a website with a certain level of service and support, disk storage, input response time, I/O throughput, CPU cycles/program run-time, merchant services, database services, and other hardware, software and network resources familiar to those versed in the art of systems management. Dynamism in resource use can be built into automated systems, such as e-mail systems, that apply algorithms to balance various demands for the resources, but these programs do not operate interactively with the people using the programs that are requiring the resources

Other resources that can be allocated are length of messages, location of storage resources (seek and retrieve times are significantly improved by co-locating information rather than having it distributed around several storage areas), storage (when more storage is needed is it extended in small amounts or large), types of backup (constant, frequent, infrequent, never—for a day, for a week, for a month, for a year, for a century), security (query every operation), security (query certain types of operations like write, delete), security (respond by dropping a connection, respond by issuing a warning, respond by calling the cops), program priority (does the user have assured absolute CPU cycles, relative CPU cycles—some sliding scale based on percentage), network connection (go through one hop, 3 hops, n+1 hops), network priority (do packets time out after some fixed amount of time), etc.

Given the difficulty and complexity in doing a “top down” analysis of the needs of the users of a system versus the system configuration, it makes sense that in addition to using the skills currently required of a system manager (monitoring system and network reports on usage) that a bottom up approach be enabled where the users can modify a system—in fact the likelihood that an administrator can anticipate or guard against all conflicts between user needs and administration needs in a non-interactive resource allotment system insures that there will always be unhappy users.

By creating an administration system that allows the users flexibility in responding to administration requirements through the use of a range of resource tokens, the administrator retains tight control over the nature and type of latitude given the user while having a dynamic, interactive system that engages directly with the needs of individuals. Such a system is that outlined in the administration portion of this disclosure.

An additional measure of flexibility is provided by allowing users to transfer tokens for resources between each other. Users thus not only negotiate resource allotments with the administration, but by allowing users to transfer resource allotments between each other they can compensate for having resources they do not value for resources they need immediately without waiting for administration to grant a request for an exception case where the user has consumed their additional resources. In this manner, a system administration can define broad systems architectures and user allotments/allocations with the confidence that individual users' unique needs have a mechanism for expression. This allows the users to assist in load balancing the system while providing additional methods for monitoring the resource usage on the system (traditional systems being poor at indicating how large a need may exist for a resource once that resource is depleted, this invention, by showing the value of freely traded resource tokens, carries a clear indicator of the size of demand based on traditional supply and demand mathematics).

For example, user A's work is dominated by e-mail. Consequently, A is constantly being constrained by the IT system for exceeding the bounds for mail storage, message size, and content types that are not normally allowed through the firewall. This user constantly experiences mail delivery problems for these reasons that result in work delays. User B next door works primarily on the web and is discouraged by the many hops his interaction takes through the corporate system, the lack of caching speed, the lack of bandwidth due to having to share his access with thousands of other employees. User C wishes to use internal video conferencing but is prohibited from doing so because of fears of network degradation if “everybody” starts doing so.

As noted above, resources can be allocated in a number of different ways. Base resources, such as e-mail, can be allocated or allotted to everyone based on some allocation system such as an equal bandwidth for each individual. As-needed resources, such as video conferencing, can be also be allocated based on some allocation system, such as FCFS. However, as discussed below, these as-needed resources can also be allocated according to the present invention using tokens. Once the resources have been initially allocated, the users can then reallocate the resources according to the present invention again using tokens.

One way of reallocating the resources, in accordance with the present invention, is by negotiation using the tokens. By providing the users with tokens, as discussed herein, each user is able to address their most pressing problems. A is able to use a token to allow longer and more e-mail messages to get through for special cases. B is able to connect through a reserved portal on the firewall when connectivity to an external website is critical. C is able to finally video conference since administration finally has a means of controlling the overall amount of such traffic on the internal network, and thus administration can allow resource intensive applications without fear.

Another way of allocating resources, in accordance with the present invention, is via barter. In this stage the users can engage in a barter where they exchange resources they do not need for resources they desire. User A trades his video conferencing access tokens to user C in exchange for additional disk storage tokens. User B trades video conferencing tokens with user C for some other resource tokens to gain additional high priority web access.

A further way in which resources can be allocated or reallocated, in accordance with the present invention, is via auction. Assume two users C and C′ who both use video conference resources a great deal and are competing for the same resources. In this case, an auction system can be used to settle disputes on the basis of highest bid in a traditional auctioning manner. When the system administrator has set a market price for the resource, the auction is not only a negotiation between the users who bid on the resource but also between the users and the administrator.

The present invention particularly applies to the allocation and management of any type of resource limited, time based resource and, for the purpose of explaining the invention, this discussion will concentrate on demand type communication resources, such as video conferencing communication resources. The present invention also applies to resources that have been allocated in other ways, such as a base resource like e-mail. The present invention has two related but distinct aspects: 1. The initial allocation of the resource, such as the video conferencing “channels” that carry the video conference; and 2. Negotiation over the allocation of the resource or the management of the resources as they are being used, such as how to disable users when the resource degrades.

The particular need for the allocation of channels for network resource intensive applications, such as those that move large amounts of image data (such as video conferencing), is met according to the present invention by providing a method of scheduling a multimedia conference on a network, including the steps of: specifying available time slots for use of the network for multimedia conferencing; defining a plurality of priority levels for access to the time slots during a specified period of time, and a number of available tokens for each priority level; distributing the tokens to users according to their needs and command on the resources of the network; and auctioning the time slots to prospective users using the tokens.

The need for the negotiation over the allocation or ongoing management of the resource is met according to the present invention by providing a system of software applications that allow network administrators to readily identify and terminate network applications on the basis of a stored profile of those applications, a profile being a collection of information about the application considered important by the administrator. It should be noted that unlike other systems, the profile specified within this invention allows negotiation by the user of the impact of an administrator action within limits set by the administrator. The present invention allows the administrator greater selectivity than other current systems which require that users and applications be completely or partially blocked. By allowing the administrator to be more judicious in terminating applications and by creating a mechanism that allows the user to designate the importance of an application at a particular time, users will be more satisfied with the manner in which the networks are managed since they will have the option of protecting running network applications that are currently vital to the user.

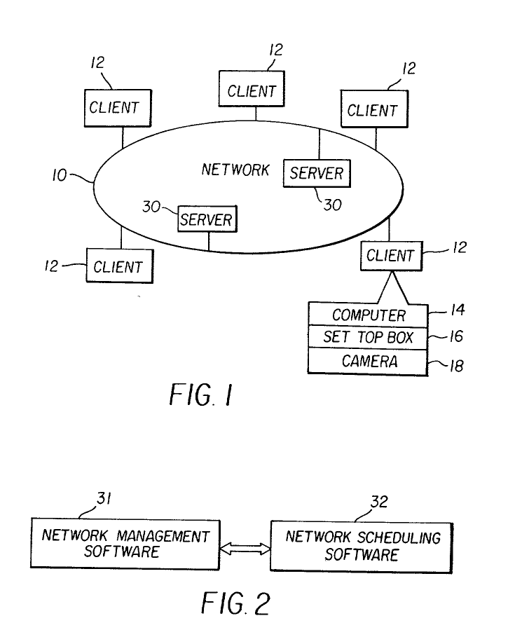

The present invention can be implemented in a system, such as shown in FIG. 1, which depicts a simplified view of an exemplary local area network 10 that conforms to a client server model. The following illustration will be directed to the client server model, however, it will be understood that the invention operates in the application layer and is therefore not dependent on the model of the network that is employed. For example, the invention may be used in a network that operates on a peer-to-peer model. The terms “client” and “server” are used to refer to a computer's general role as a requester of data (the client) or provider of data (the server). Any component that has an IP address can be a client. For example, network clients can include a conventional personal computer (PC) 12, an Internet appliance 14, or a set top box 16, or a web camera 18. In a typical video conferencing application, a camera may be attached to and obtain its IP address from the personal computer 12, or may constitute an independent web camera having its own IP address. A network server 30, such as a conventional server computer, runs a conventional multimedia communication management application. At least one computer on the network is used as an administrator's computer. The administrator's computer can be any one or more of the computers on the network that the administrator chooses. The present invention allocates time slots on the servers 30 and the LAN 10 to the clients 12 for video conferencing and then manages the use of these resources after the conferencing has begun.

As noted above, the two main software components that comprise this invention include a network management software application 31 and network resource barter and auctioning system or scheduling software application 32 (see FIG. 2). The network management software application 31 runs on the administrator's and users' computer(s) and allows negotiation with the administrator over an allocation of a resource and allows a network administrator to kill specific network resource-using applications run by specific users on the basis of administrator assigned ranges of priorities in conjunction with user chosen priorities selected from those ranges. The network scheduling software 32 runs on the user, administrator and server computers and allows the scheduling of the server and LAN resources. The network scheduling software 32 can operate wit, or separately, from the network management software 31. It should be noted that by creating a token-based administration negotiation system between the user and administrator, an especially appropriate foundation for a token based bidding system for user to user negotiation is also provided.

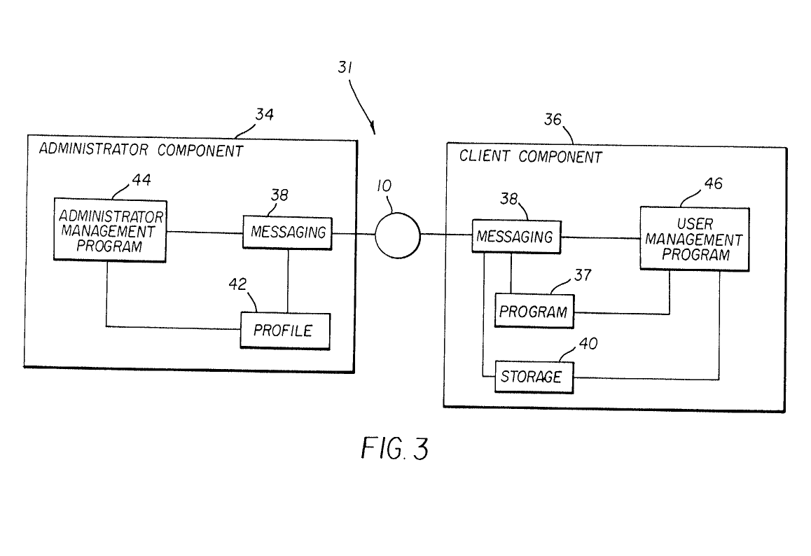

The network management software 31 includes an administrator component 34 (see FIG. 3) that is run on any computer used by the administrator, a client side component 36 that is run on all clients 12 connected to the network 10. Each of the components includes conventional messaging routines 38 that transfer data between the administrator and client side components. The client side component 36 runs and terminates client programs 37 on the clients 12. The client side component actually runs the programs 37 and acts as a proxy for the administrator component 34. According to a preferred embodiment, the network management software 31 is an application that runs on both the administrators'computer and on all network clients connected to the network 10. Alternatively, the client side component 36 of the network management software 31 can be in the form of a plug-in module that is a component of network-using applications (for example e-mail or web client applications) or as a component of an operating system on a network client.

After installing the client side component on all clients 12 on the network 10 falling under the administrator, the administrator uses the administrator specific component 34 to send a program profile to the client side components 36. The administrator component 34 receives inputs from the administrator relating to the assignment of a range of priorities, and parameters related to restraints on the usage of those priorities (which can include time, location, user, and time till termination but not restricted to only those parameters) for each program 37 that is run by a network client. This collection of priorities and parameters is referred to as the profile. When an auctioned resource is involved, the priorities for the application using the resource are the token values used to capture the resource. It is the profile that contains the default token data that can be used to negotiate access to a resource with the administrator or with other resource holders through the means of an auction.

The information thus collected relating to the programs 37 on a particular network client is sent to a core storage file 40 on the network client 12. Such storage files can be of any format, including those used by database applications. The collected information is also sent to a master profile file 42 containing information on all the applications on all the network clients that is accessible by the administrator component 34. Additional copies of the master profile for backups or mirrors may be made using any of the well-known change management procedures (such as procedures indicating when all files are current and which of the files is the most recent and keeping files from being read while they are being modified).

In addition, a sub-set of the parameters can be designated as default. Even though the user of a network client 12 can be presented with a range of priority choices, in the absence of a choice by the user, an administrator or user designated default can be used. The default can be either absolute, meaning the default is always the same, or dynamic, meaning it changes in response to a condition such as (but not confined to) the time of day.

One example of such a profile would be the e-mail application on a device we shall call Alpha. This e-mail application might be assigned an infinite amount of run-time at token value or priority 5 (the lowest priority), 20 hours of run-time per month at priority 3, and 2 hours of run-time per month at priority 1. On the same network, a different device, Beta, would have a resident profile that would allow infinite run-time at priority 5 and 40 hours at priority 1. The profile for an auctioned resource would include the auction value and the amount of time allocated for the resource as a result of the auction.

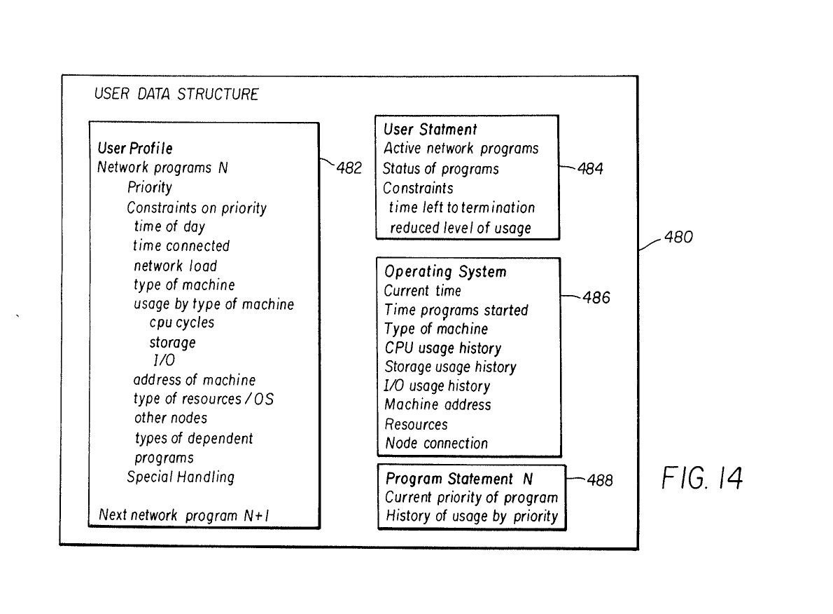

When the user of the network device attempts to run a program (such as the e-mail application on networked device Alpha) they first run an intermediary program. This intermediary software reads the administrator established profile (see FIG. 14) for that client, application and user, then reads the available priorities and their constraints (for example, the user may be informed that they have infinite hours remaining of priority 5, and 1 hour remaining of priority 1 time) and makes them available to the user. The time remaining is obtained based on a calculation based on the fields Current Time/Time Program Started.

In this embodiment, the intermediary software runs the application and opens a window on the network device (assuming the device supports a windows interface (such as Windows, Windows NT, Unix, or the Apple system or whatever graphical interface is common at the time).

If such a window is already open, the invention will add a listing to the other listings in the window for the application that has just been opened. Through the window, the invention enables the user to assign or change the priority of all running network-resource using applications on that device so long as the changes fall within the range of priorities established by administrator in the profile for that device and as long as such changes are within the current usage constraints (for example you could not assign a number one priority after you had exceeded your allotment of hours of number one priority run-time for a specific application).

In the opposite case, if allowed in the client profile provided by the administrator, clients may immediately downgrade applications to preserve value. Administrators may wish to encourage such behaviors by adding incentives and rewards in the form of additional points to clients that respond promptly and aggressively to reduce their resource usage.

In addition to bidding a higher token or aggressively reducing tokens, the client may participate in a barter or auction transaction where clients transfer like or unlike value resource tokens between one another (for example a token for time for a conference may be exchanged for tokens for running web browsers at a higher priority or any other resource participating in the system, such as parking privileges and discounts on the cost of purchased items, such as food.

For example, client A may badly need to continue a session and offers up a token for prized parking location for a week, the parking location being another type of limited resource that can be handled by the present invention. Client B accepts the bid and systems are updated such that the parking place is allocated to client B's profile that in turn loses network resource tokens from their profile.

To facilitate the use of this system with resources that are not connected directly to the common network, to enhance security and convenience and in keeping with providing a parallel means of disabling and enabling resource usage, in a preferred embodiment, a user would be enabled with a portable means of storing their profile and resource usage information. This portable means could be any form of readable/writable storage such as a magnetic stripe card, chip cards, and cards using forms of optical, chemical storage or storage technology yet to be developed.

The portable means of storage requires a mechanism for disabling the user from overextending their use of a resource. One means familiar to those versed in the art of protecting against counterfeit information is to activate a portable card by moving the information that allows access to resources to the card and deleting or debiting such access data from the storage resident on the network. This transfer can be on a piecemeal Oust videoconferencing privileges) or total (all privileges are moved from one storage location to another) basis.

Another protective process is to copy in full such information to the card from the network resident storage, unlock use of the card, and lock (disable from use but not delete or modify) such information resident on the network. The other side of the process involves moving modified contents from the card back to storage resident on the network (either partially or in full), re-enable the network resident storage and then disable the card.

In the preferred embodiment, the portable storage can be but is not limited to a card that has a display that shows the debiting of resources. In addition, the card would be the single storage location for the user's information thus avoiding the need for controlling multiple copies of the same information. The card would be hooked to the network via wireless means. Alternatively and in addition, multiple wired means can be used for connectivity (ac lines, 10 base T, twisted pair, RS232, and other connectivity standards familiar to those versed in the art of network hardware). The hardware for connectivity can be part of a cradle or any device with a similar capability (such as a digital camera) that would interface to the card. Such a cradle would be connected to the user computing device and thus act as a controller for such a device while being connected to the administration system in a manner other than the method in which the computing device is connected to the network. This alternate means of connection provides protection from network outages. Alternatively, the connection and read/write capability can be made in whole or in some part, a part of the card.

In addition to displaying information, running programs and allowing the user to choose from a constrained group of priorities, the software of the present invention should maintain a list of currently running programs and their profiles, and look at the system resources (such as date and time) and use those to recalculate dynamically allocated resources in the core profile file. For example, the user runs an application of priority 1 where that priority is available for one hour a month. The client side of the invention must know the month, and deduct the time in increments chosen by the administrator (normally seconds or minutes).

A special case exists where the application is accessing one or more other user applications, such as when two or more users are engaged in video conferencing. In this case, the highest profile in the group must be propagated to all participating devices. When an application joins a conference, its profile is compared to the profile of the other application. This comparison takes place when the device proposing a connection has its client side software send a message containing the profile to the receiving device. When the receiving device runs a program accepting the invitation, its client side software component of the invention compares profiles for the just run application. The higher profile is then placed in the currently active file accessed by this software invention on both machines. In this manner, the highest profile is propagated to all participants.

As noted previously, the system of the present invention allows users to allocate/reallocate resources by auction or by bidding on resources and for this discussion it will be assumed that the users have tokens, created by the administrative portion of this invention which is covered later, which are a proxy for money and which have values that correspond to priority of access to (and continued use of) the resource with a lower value token having a higher priority. That is, a token with a value of 1 has a higher priority or value than a token with a value of 2. By price, we mean a value expressed in tokens. The present invention uses the bidding concepts of market orders and limit orders where a market order is an order placed at the prevailing price for the resource and typically captures the resource, and a limit order is an order to proffer a token at a value no greater than X where X is a token value. A limit order is essentially a bid for the resource at some value less than the prevailing price, which could be another bid. A limit order captures the resource when it is the highest bid at the end of a bidding period.

Before allowing users to schedule user resources, a database (which can be comprised of any sort of rules formatted information such as flat files, XML, relational, object oriented, or as yet to be created formats) needs to be created. In an example where the system is allocating time slots for video conferencing time on a network, such as depicted in FIG. 1, the database would typically include entries for all of the available time slots of the video conferencing system, such as entry for each working hour. Each time slot is assigned an ID that is correlated to the date and time of the slot, such as date-time where a conference at 10:00 am on Aug. 1, 2001 would receive a conference ID of 200108011000. The database includes entries for the number of meetings that can be conducted at each time slot. The database also includes an entry for an assigned market price for each of the time slots, along with entries for storing the orders (market and limit) and an optional entry for storing the number of bids for each time slot. The database further includes an entry for the closing date/time of the bidding for each time slot where the closing date can be set manually for each slot or set by a formula such as X weeks before the meeting date. Rather than having the date and time correlated to the time slot ID, the database can optionally carry entries that indicate the date and time of each time slot. For users, the database includes entries for a user account ID, a users name and a token balance available to the user to spend on meetings for each value of token possible in the system. For example, if the system allows tokens with values of 1-5 the database will store the number of tokens that the user has at each of the token values. This database could also store other information that might be associated with the event being scheduled such as the names of attendees, the security level of the meeting, the locations of the attendees, etc. The conference ID is a unique identifier that would allow access to any such “metadata” about the conference that might be added as desired by the users. This database can be created using conventional database technology.

When creating the database, a system administrator determines the number of time slots while system capacity determines the number of meetings possible for each time slot. The administrator also assigns the market price to each of the time slots. The price can be determined in a number of different ways. The slots can have a fixed price. The market price can be set using an algorithm such as price=constant*number of days before meeting. The price can be set by supply and demand such that it changes as bids are submitted. The price can also depend on congestion where a higher congestion time slot gets assigned a higher price.

As will be discussed later herein, a user/administration database is created that includes user profiles that include information such as the users level of security, how many tokens of each value or class the user has available in the user's account, etc. The initiation by a user of an auction application, such as the network scheduling software 32, causes the user/administration database to be accessed by the auction software, the security of the user is checked to insure that the user is in fact allowed to participate in an auction for that resource, the users tokens are made available, etc. Once the auction (or negotiation relative to the market price) is completed, the results of the auction are checked to determine what results of the auction need to be transferred to the particular database of the winning user and from the losing user, such as by updating the users token account balance. The administrator may prohibit certain resources from being made available to certain users, or if available may prohibit certain users from modifying their administrator designated limits.

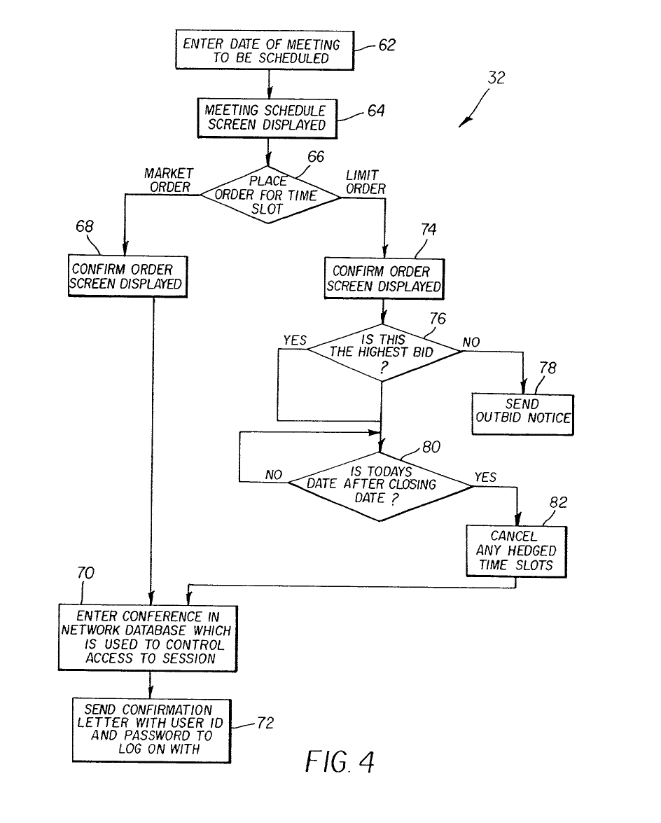

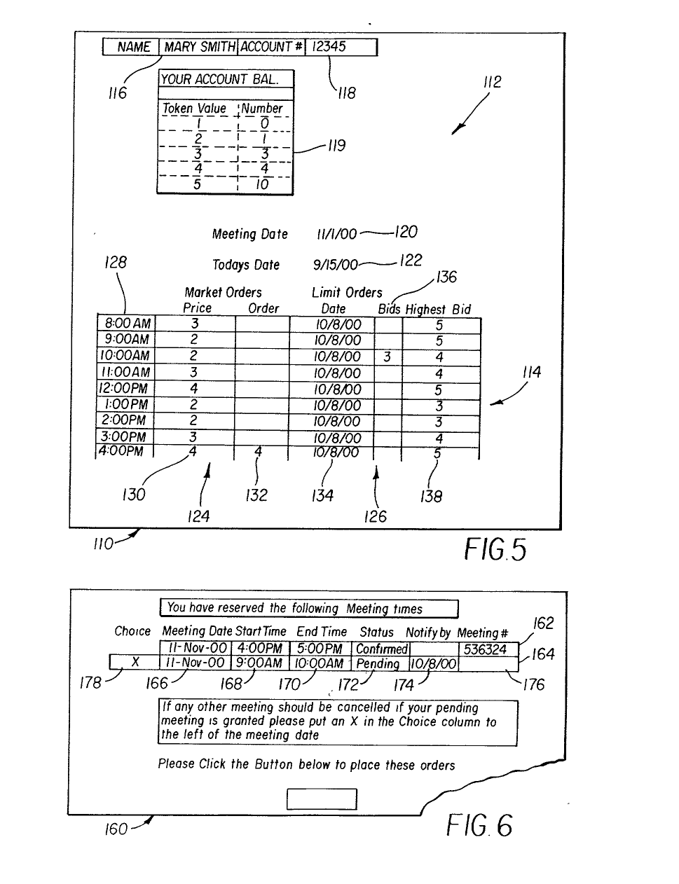

The network scheduling software 32 allows a user to enter 62 (see FIG. 4) a desired date for a meeting, the database is accessed and a display, such as depicted in FIG. 5, is presented 64 to the user. The user would then enter 66 an order for a meeting and be presented a display, such as depicted in FIG. 6, showing what orders the user had entered and allowing the order to be placed. When the order is placed, the system determines whether the order is a market order at the price of the slot or a limit order.

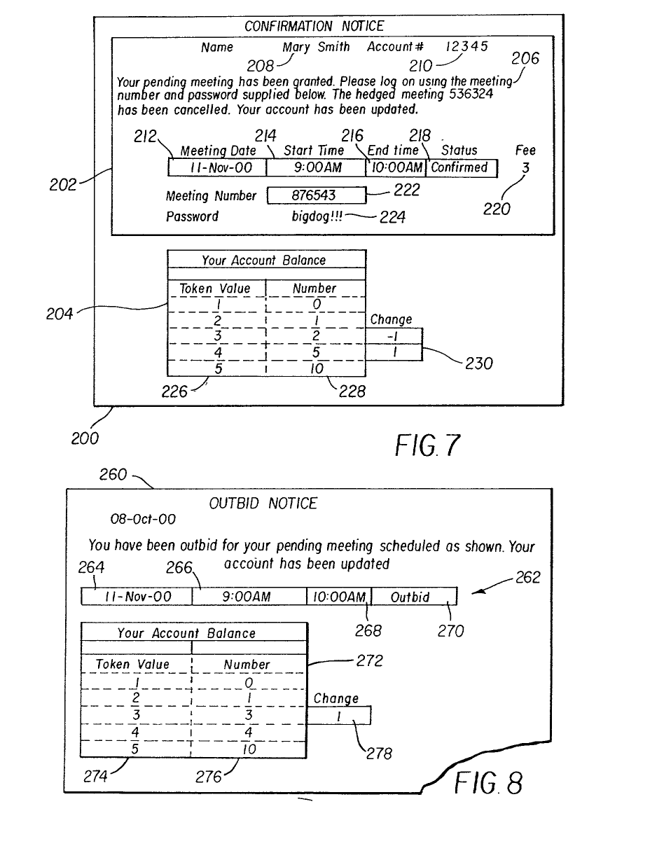

When the order is a market order the time slot is reserved 70 for the user by updating the conventional network/resource control database or conference database for the video conferencing system that controls access to the resource. The users account balance is updated and the user is presented with a confirmation display, such as depicted in FIG. 7. This screen can be used for both market and limit orders. It is possible to have separate screens for market and limit orders or to separate them on the screen of FIG. 7 as could be decided by performing studies of user interaction with the software. The system also sends 72 the user a confirmation letter regarding the reserved time slot(s).

When the order is a limit order, a confirmation screen is also presented 74 similar to FIG. 7. The system then determines 76 whether the bid is the highest bid. This determination can be performed after each bid as depicted or the system can make this determination for each time slot based on an automatic trigger such as an event triggered each hour of the day as is shown by the arrow showing another entry point into this flow. For the bids that are not the winning bid, a notice that the user has been out bid, such as depicted in FIG. 8, is sent 78 to the user. When the bidding period closes 80, the winner has other limit order bids for alternate time slots that were ordered in the same order session cancelled 82. When the meeting date arrives, the user conventionally logs on to the conferencing system using the approved conference number and password supplied with the confirmation order.

The display 110 provided to the user upon entry into the system for placing a time slot order, as depicted in FIG. 5, preferably has a portion 112 for user information display and a portion 114 for slot information display. The user information 112 includes fields for user name 116, account number 118 and account balance 119 showing the number of each token value awarded to the user. This figure shows that Mary Smith has 10 tokens with a value of 5, 4 tokens with a value 4, etc. The meeting slot information display 114 has fields for the meeting date 120 and today's date 122. The display is also divided into portions for market orders 124 and limit orders 126. The display 124 has fields for the time 128 of the time slot, the market price of the slot 130, and the price 132 paid for the time slot showing a time slot allocation where the time slot at 4 PM is shown as allocated for a price of 4. The display 126 includes fields for the date 134 of the meeting, the number of bids 136 and the highest bid 138. In the example of FIG. 5, Mary Smith has placed a market order for the 4 PM time slot and a limit order for the 10 AM time slot, bidding a #3 token which has a value less than the market price (#2 token).

The submit order display 160 (see FIG. 6) preferably notes that a reservation has been made and includes information about confirmed meetings 162 as well as contingent meetings 164 for which bids have been submitted with fields for meeting information such as date 166, start and stop times 168 and 170, status 172, notify date 174 and meeting ID 176. A choice field 178 is also provided for the user to specify which contingent meetings can be canceled when a meeting time slot is granted.

The order confirmation display 200, as depicted in FIG. 7, includes a portion 202 which provides information about the meeting time slots and a portion 204 that includes information about the users account balance. The display 202 notes 206 which alternate limit order time slots have been cancelled and includes fields for the name 208 of the user reserving the slot, user account 210, date 212, start and stop times 214 and 216, status 218, the fee paid 220 for the slot, meeting number 222 and password 224. The account balance portion 204 includes fields for identifying token values 226, a number 228 of tokens of each value and a change 230 in the number of tokens of each value.

The display 260 (see FIG. 8) notifying the user that they have been out bid for a slot includes a slot information portion 262 including fields for date 264, start and stop times 266 and 268, and status 270. The account balance portion 272 includes fields for identifying token values 274, a number 276 of tokens of each value and a change 278 in the number of tokens of each value. As soon as the user is outbid, an outbid notice is sent to the user's terminal. If the user is still logged on when that occurs, the user could respond by immediately increasing the bid. This could introduce a de facto live auction should both bidders choose to act in such a fashion.

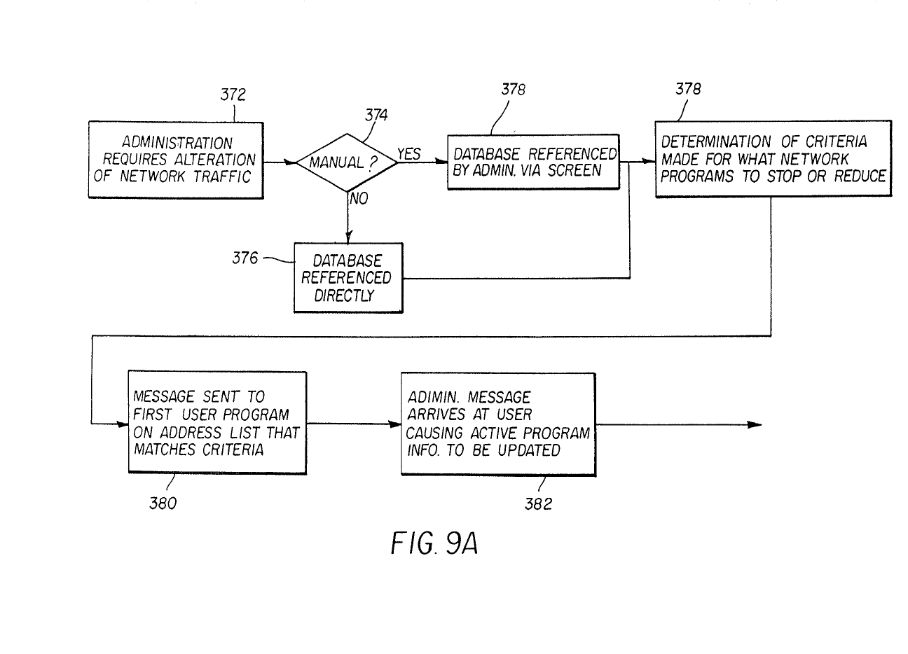

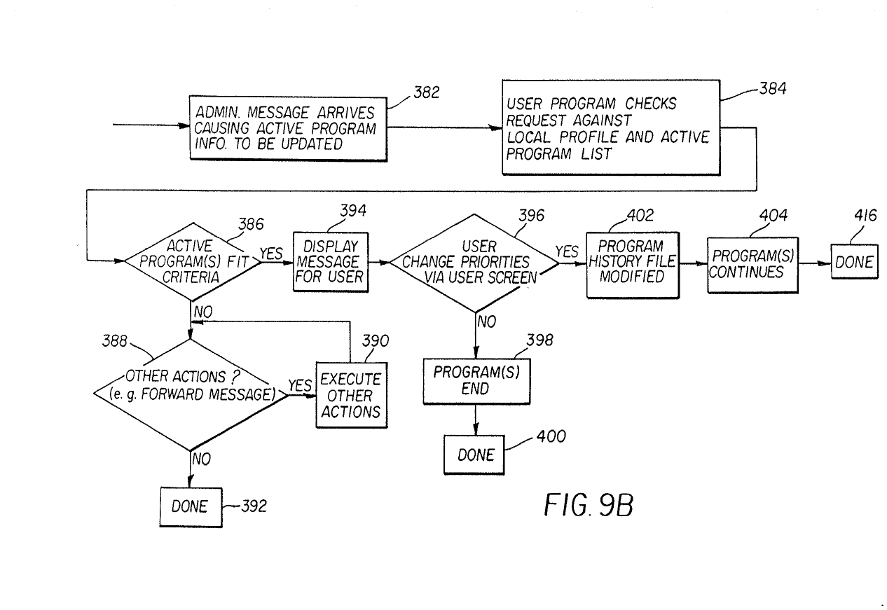

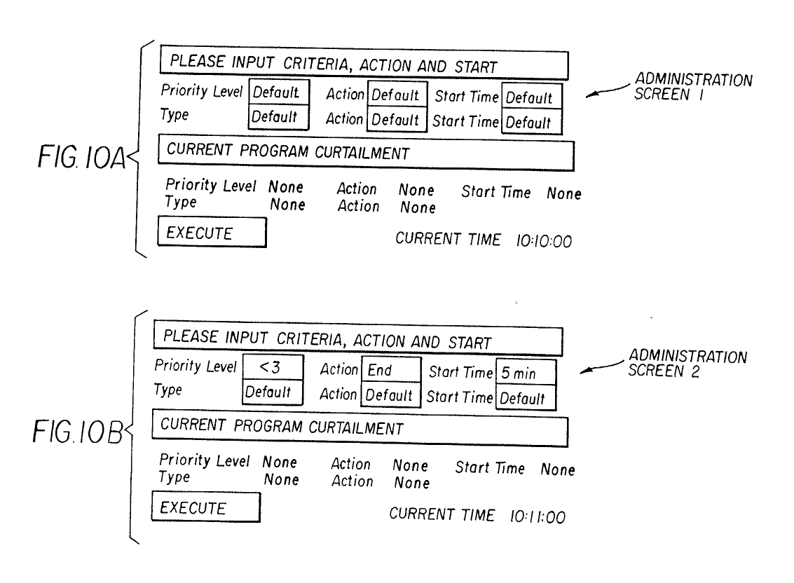

In managing ongoing use of allocated resources, the administrator typically uses a conventional network monitoring tool to monitor the state of the network and finds the performance of the network being degraded beyond acceptable levels (such as when a server unexpectedly goes off line), the administrator uses the administrator's management program to access the profile information to determine what accesses or uses of the resource can be terminated (see FIGS. 9A and 9B) and sends a terminate message to all devices (or some subset based on information in the master profile), all (or some ranked subset) of users running all or some ranked subset of network resource using applications (like video conferencing).

The administrator's application works in conjunction with network usage reporting software, the administrator's insight and the application's capabilities to send a message to all the client components on all devices instructing those components to send back a message on what network-resource using applications are currently active, thus providing a detailed overview of network use, the components of that usage, and in a preferred embodiment a preferred strategy for dealing with the network overload. The administrator then has the option of implementing either the automatically generated solution, choosing from a palette of solutions, and manually designing a solution from scratch or tailoring one of the other solutions.

In this example of the invention, the administrator recommends that applications operating at priority 3 be terminated until a specific time, such as 3:30 PM. The time is arrived at on the basis of algorithms familiar to the network administrator and appropriate to the particular network being managed.

On the basis of the preferred solution, the invention sends out a message that instructs the client version of the user management program to check its list of current active applications for resemblance to the profile of applications to be terminated.

Upon checking its listing of active program profiles, the system updates the parameter indicating when it may run and notifies the user that certain active applications on the user's network device are candidates for termination within the amount time fixed by the system administrator in the profile file, for example 4 minutes, and that the applications will remain terminated till 3:30.

In the preferred embodiment of this system, this message will reach the user's device by some communications system other than the system that is being managed. Some examples of such alternate systems (but not constrained to these systems) are identical but parallel networks, telephone, IR, direct or wired contact between devices or between holders of devices or radio frequency communications. For example, a confederation of devices using RF to connect and HAVi or JINI (two networking well known languages familiar to people in the art) to communicate has a client that due to a hardware failure sends out spurious packets in such abundance that the network is overloaded. Based on network performance monitoring software, this invention could automatically send out a termination command to the malfunctioning device or to a separate device (such as the card and cradle mentioned previously) that controls network access and power to the malfunctioning device.

In the preferred embodiment where the applications are running interactively with a user on a network client, the message is received by the client portion of this software invention and brought to the attention of the user by the client side of the invention.

In this embodiment a window can appear in front of all other windows accompanied by an audio warning and a countdown indicator along with an interface that shows the users what options they have for changing the priority of the termination candidates (including auction windows). Other means of gaining the users attention include but are not restricted to blinking icons, animations, changes of color, and spoken voice.

If the user does not change the priority of the access to the resource, using system calls, the client side of the invention, the manager 346, waits till the previously mentioned time limit has elapsed and then terminates the program. If the user attempts to restart the program before the allotted time, the client side invention will notify the user of the amount of time remaining (till 3:30 in this example) till the application can be restarted.

In addition to offering a mechanism of controlling applications, this system allows for the ready modification of network usage profiles for large networks by editing the master profile file and then automatically propagating the appropriate sections to the other devices on the network as core profile files.

This control structure can then tie into network behavior algorithms that can automatically edit and propagate network usage constraints.

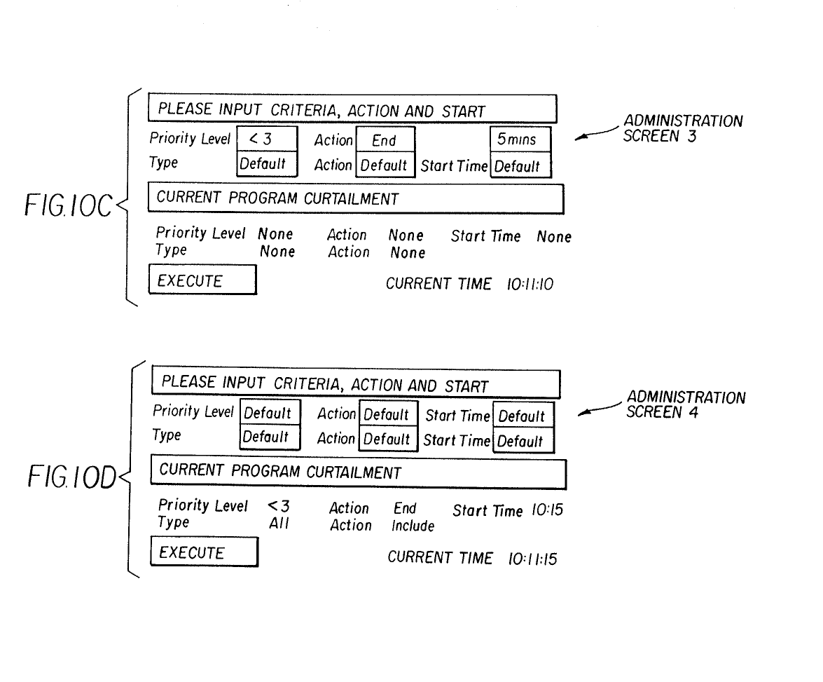

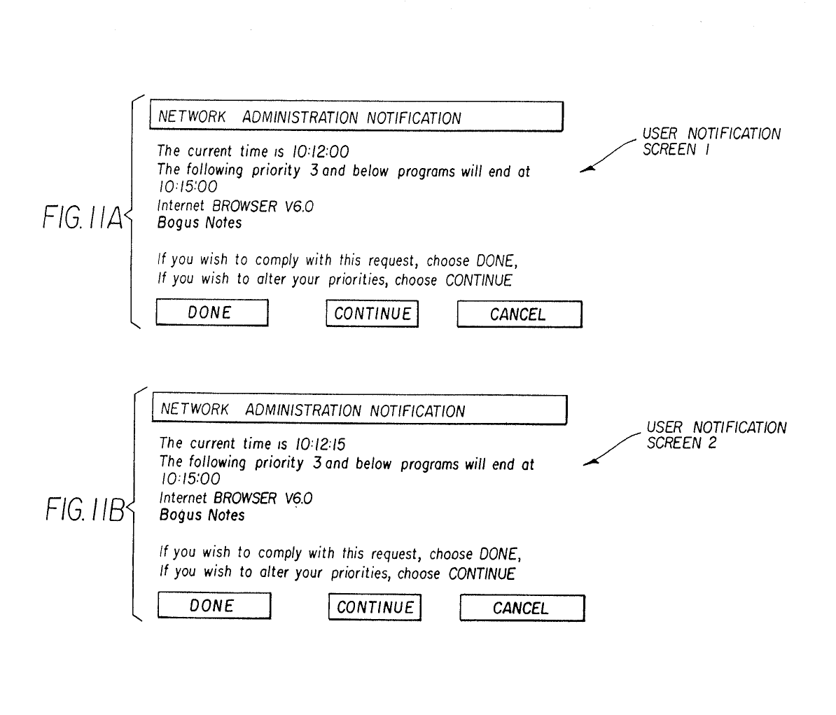

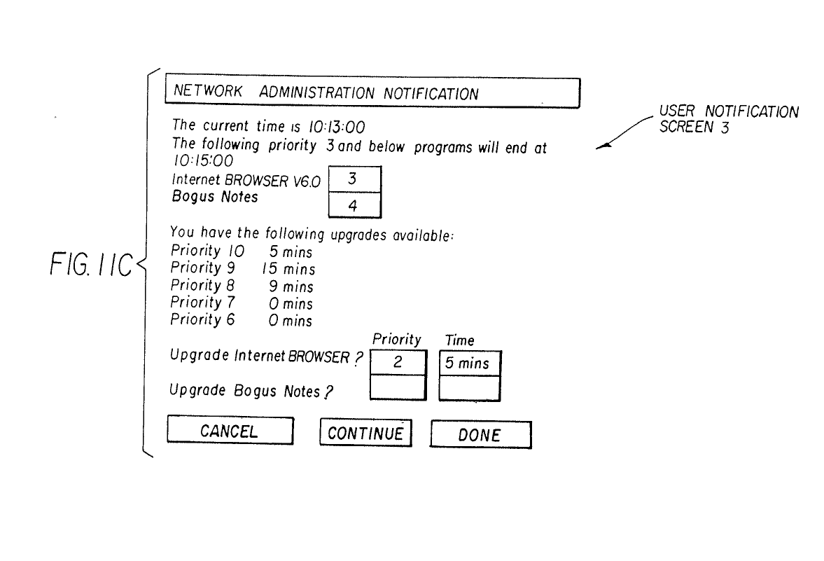

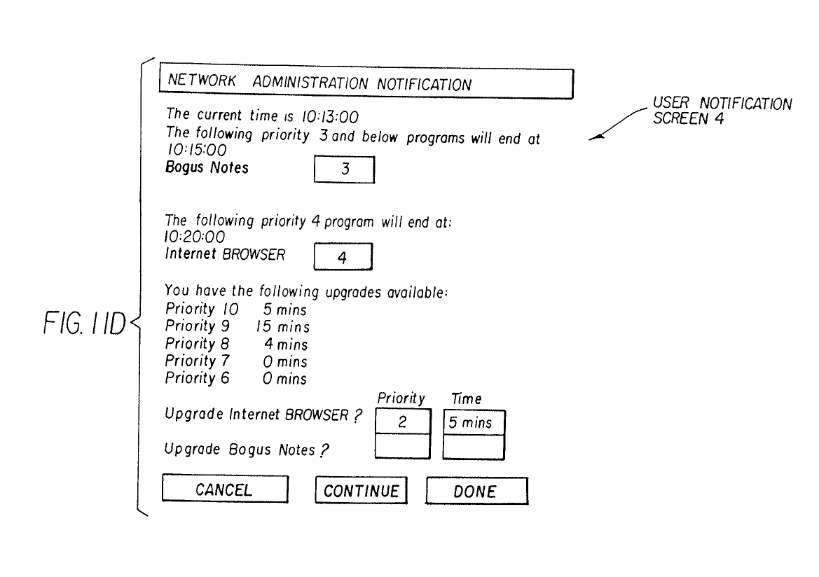

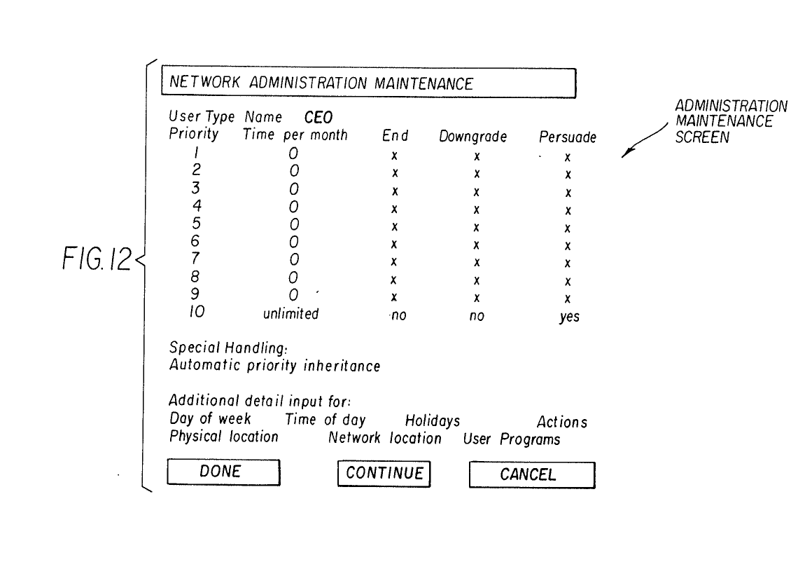

As noted above, when the administrator finds the performance of the network being degraded and the system requires alteration of the network traffic 372 (see FIG. 9A), the flow of operation allows 374 the administrator to access the database manually 376 or through an administrator screen showing the status. This data typically shows what resources are used by what level of access. The administrator then specifies the criteria (see FIGS. 10A-10B) for ending access to the resource by specifying criteria 378 or limits indicating which resource uses to end or reduce. The system then scans the profile information and sends 380 terminate notification messages (see FIGS. 11A-11D) in sequence to the devices of the users accessing the resources who meet the criteria for termination. The administrator component 34, when it receives 382 the message, accesses the database and determines 384 what resources (programs in this example) fit the profile of accesses to terminate. For those programs or resource utilizers that do not fit 386 the profile, the system allows other actions to be executed 388, 390 and 392. For those programs that meet the profile, a message is provided 394 to the user and the user is allowed to change 396 the priority of the use by using tokens with the appropriate value.

The user can, at this point, participate in an auction or barter transaction to acquire the tokens needed or to make available tokens that might be needed by others.

If the priority is not changed, the program (such as the video conference in progress) is conventionally terminated (398 and 400) at the specified time using application termination systems calls appropriate to the operating system and familiar to those versed in the art of systems programming, such as the Unix “kill ‘Program ID’” command. If the users spend the tokens needed to upgrade the priority, the system modifies 402 the profile in the client, updates the user's account balance in the administrator database and the program continues 404 and 406.

If the network continues to degrade or remains degraded, such as when all of the users upgrade their priorities, the administrator may have to restart the process of selectively terminating applications. Such a situation may require users to spend additional tokens to continue their use of the resource. This situation may even result in a user who has paid for continued use of the resource being bumped off by someone who has higher priority tokens. That is, the administrator in such a situation essentially negotiates termination by raising the priority (or token value) required to continue using the resource when the system continues to be degraded.

It is possible for a user to desire to extend the use of a resource rather than being bumped off and may bump someone else off or not let someone else start a new use when the system is full. If the systems administrator wants to allow bumping (such as by a high priority user), the same rules that apply when an airline passenger is bumped are preferably used (i.e. the user gets his money back or a seat on the next available flight). In such a situation using the airline analogy, some users might volunteer to be bumped for a fee (the high priority user might pay with some of his tokens) or they might come from the administrator's bank account.

FIGS. 10A-10D depict a series of screens used by the administrator to initiate the termination of one or more programs that are using a resource. FIG. 10A illustrates an initial screen displaying all default values into which the administrator enters criteria for searching the profiles for termination candidates. FIG. 10B shows the administrator specifying that programs with a priority level of less than five are to be ended in five minutes. FIG. 10C depicts the administrator executing the request by activating the “execute” button. FIG. 10D depicts an acknowledgement screen that shows that all programs with the specified priority will be terminated at 10:15, approximately 4 minutes from the current time of 10:11.

FIGS. 11A-11D depict displays used by the user in changing the priority of a resource in use when the system administrator has selected the applicant for termination. FIG. 11A depicts the display provided to the user to notify the user that one or more programs using the resource are about to be terminated. This example shows that two programs are to be terminated in 3 minutes. FIG. 11B depicts the user choosing to alter priorities of the programs by activating the “continue” button. FIG. 11C shows the user altering the priority of the browser program to avert termination. This display shows the extensions of time each upgrade or token value will obtain. This display also shows the user entering an upgrade of 2 worth five minutes and then activating upgrade with the continue button. FIG. 11D depicts the confirmation showing the status of the programs and particularly showing the extension of time for the browser.

FIG. 12 depicts a system administrator screen that is used to access the priority database for users and make changes thereto. In this example, the administrator is looking at the profile for a user type named CEO. As implied by the name, this user type would be likely to have the maximum of resource allocation possible and any user having this type associated with them in a database would have such resources allocated for their personal use. This particular example screen indicates a system where priorities or token value range from 1 to 10, where each priority can be assigned to a particular amount of time per month. The priority is further defined in terms of being a priority that includes immunity from termination, immunity from downgrade but is not immune from requests to voluntarily kill programs. Under special handling, the priority of the CEO's programs automatically extend to any programs the CEO is dependent on, such the other programs interacting with the CEO program during a conference. At the bottom are additional priority definition fields that might be useful. Such fields would allow the priority to be assigned to a particular day or set of days (weekends versus workdays versus holidays) or particular times during the day, or particular physical locations or virtual locations on a net. Other forms of data typical of systems management which could be included or pointed to by the table are usage of storage media, security, types of function calls (read, write, delete, copy, move), data content types and many others familiar to those versed in the art of systems and network management.

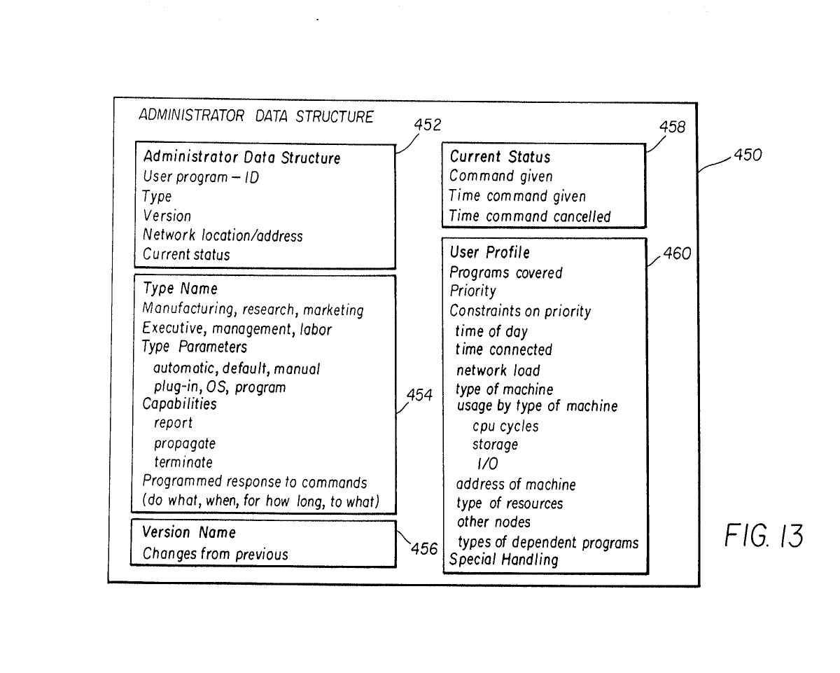

FIG. 13 shows the data structure for the administrator component while FIG. 14 shows that for the user manager. The administrator structure 450 includes (but is not limited to) five sets of data: administrator's data 452, type data 454, version data 456, status data 458 and user profile data 460. In this example, the administrator is looking at the profile for a user type named CEO. As implied by the name, this user type would be likely to have the maximum of resource allocation possible and any user having this type associated with them in a database would have such resources allocated for their personal use. This particular example screen indicates a system where priorities range form 1 to 10, where each priority can be assigned to a particular amount of time per month. The priority is further defined in terms of being a priority that includes immunity from termination, immunity from downgrade but is not immune from requests to voluntarily kill programs. Under special handling, the priority of the CEO's programs automatically extend to any programs the CEO is dependent on, such the other programs interacting with the CEO program during a conference. At the bottom are additional priority definition fields that might be useful. Such fields would allow the priority to be assigned to a particular day or set of days (weekends versus workdays versus holidays) or particular times during the day, or particular physical locations or virtual locations on a net. Other forms of data typical of systems management which could be included or pointed to by the table are usage of storage media, security, types of function calls (read, write, delete, copy, move), data content types and many others familiar to those versed in the art of systems and network management.

FIG. 14 shows the data structure for the user. The user data structure 480 includes four tables of data: with profile data 482 table containing pointers to detailed information in the status data 484, OS data 486 and program data 488 tables. The information in this example is typical (but not restricted to) that data that would be valuable to the user display software that enables a user to gauge the impact of an administration decision and respond accordingly.

An example of the use of this data by the user display software would be a user is connected to an Internet service provider. The provider administrator sends out a notice that customer base level priority websites are going to be taken off-line in 15 minutes. Assuming the user is running a website, this administration notice is displayed in a window along with information that is pertinent to the user such as, is the site currently active, it's type and level, usage statistics and what upgrade tokens are available. If the user find that they are candidates for termination then the user can respond by submitting an upgrade token to insure continue access to the website rather than allow the website to be temporarily terminated. If the user is not a candidate and if the administration chooses to enable rewards for assistance, the user may terminate the website themselves to gain whatever rewards such behavior warrants from administration.

The present invention has been described with respect to allowing bidding, barter and negotiation using tokens of different values. It is possible to use tokens having the same value and allow the user to bid multiple tokens. It is also possible to use tokens for different types of resources (such as but not limited to various kinds of network, systems and physical resources) in the manner just described. The invention can consider the highest priority of the parties involved in a communication or conference when assessing whether the resource use should be terminated. It is also possible to consider a combination/aggregate priority in making an assessment. The invention can also apply to physical resources such as restaurant seating or parking meters.

An example of applying the invention to combinations of resources is bidding for a physical conference room or a restaurant seating reservation, acquiring the reservation and then bartering the reservation for additional time during a video conference.

Another example is where a client uses a device such as a card reader and an identification card with data storage capability to access a conference room. The access time is then to be debited from the person's resource account once the locked room was opened by the system in response to the card swipe and would continue being debited until the room was locked shut again by another swipe of the card.

Another example is an automated priority networked parking system in a company where parking meters would respond to a passive ID systems (such as a speedpass). The parking meters could allocate the amount of time on the basis of the ID systems and determine if the parking spot was available at certain peak times to higher priority individuals. During off peak hours anyone could park until approaching peak hours. At that point, only higher priority token possessing individuals would be allowed. Individuals possessing unused allotments of higher priority tokens would have the option of auctioning or bartering such tokens for other tokens they are in short supply of, such as tokens for commanding priority access when using the network.

Another system variation will send notices of termination to the uses of applications with the lowest priority (token value), or to the users with applications having the lowest priority and the least amount of time remaining in their use.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### PARTS LIST

10 system

12 client

14 computer

16 monitor

18 camera

30 server

31 network management software

32 network scheduling software

34 administrator component

36 client component

38 messaging routines

40 storage

42 profile

44 administrator management program

46 user management program

62-80 auction operations

82 cancel time slot

110 display

112 user information

114 slot information

116 user name

118 account number

119 account balance

120 meeting date

122 current date

124 market orders

126 limit orders

128 time

130 market price

132 price paid

134 meeting date

136 number of bids

138 highest bid

160 submit order display

162 confirmed meetings information

164 contingent meetings information

166 date

168 start time

170 end time

172 status

174 notify

176 meeting ID

178 choice field

200 order confirmation display

202 meeting time slot information

204 user account balance information

206 alternates

208 user name

210 account number

212 meeting date

214 start time

216 end time

218 status

220 fee paid amount

222 meeting number

224 meeting password

226 token values

228 number of tokens

230 change

260 outbid notice display

262 slot information

264 date

266 start time

268 stop time

270 status

272 account balance

274 token value

276 number of tokens

278 change

372-406 administrator management program operations

450 administrator data structure

452 administrator's data

454 type data

456 version data

458 status data

460 profile data

480 user data structure

482 profile data

484 status data

486 OS data

488 program data

What is claimed is:

1. A method of scheduling utilization of a network resource, comprising:
setting a market price for use of the resource;
allowing users to bid on use of the resource; and
allocating the resource to a highest bidder.

2. A method as recited in claim 1, updating a network control database with the allocation.

3. A method as recited in claim 1, further comprising presenting a display to a user showing user account balance, time slots for a desired meeting, prices for the time slots, allocated time slots for the resource and the highest bid for each time slots.

4. A method as recited in claim 3, wherein the display shows a number of bids for each time slot.

5. A method as recited in claim 1, further comprising presenting, to a user having an order accepted, a display confirming allocation of a time slot, confirming cancellation of an alternate time slot, providing a meeting identifier and a password and showing an updated account balance.

6. A method as recited in claim 1, further comprising presenting a display to a user that has been out bid indicating that the user has been out bid for a time slot and showing a credit to an account balance of the user.

7. A method as recited in claim 1, wherein the resource is divided into time slots and the users bid on the time slots using market and limit orders.

8. A method as recited in claim 1, wherein the resource comprises multimedia conference communication channels and further comprises:
specifying available time slots in the channels for use of the network for multimedia conferencing;
defining priority levels for access to the time slots during a specified period of time, and a number of available tokens for each priority level;
distributing the tokens to users according to needs and command on the resource;
assigning the market price for each time slot where the market price is measured in token value;
setting a closing date for each time slot thereby setting a date and time that limit orders will be filled;
receiving market and limit orders in tokens for the time slots;
allocating the time slots to market orders on a first-come-first-served basis;
allocating the time slots to the highest limit orders for slots not previously allocated at the closing date;
confirming allocation to holders of allocated time slots;
notifying limit order holders that are not the highest bids for the time slots of being out bid;
canceling alternative time slot orders for allocated time slot holders; and
changing token balances of users in response to the allocating.

9. A method as recited in claim 1, further comprising accessing and updating a database comprising time slot data and user data, the time slot data comprising entries for: available time slots, time slot ID, date/time of the slot, number of conferences that can be conducted at each time slot, assigned market prices for each of the time slots, market orders, limit orders, number of bids for each time slot, and closing date/time of the bidding for each time slot, the user data comprising: user account ID, users name, and token balance.

10. A method as recited in claim 1, further comprising allowing a first user to bump a second user from a resource using the tokens.

11. A method of scheduling utilization of a resource, comprising:
setting a market price for use of the resource;
presenting a display to a user showing user account balance, time slots for a desired meeting, prices for the time slots, allocated time slots for the resource, a highest bid for each time slot and a number of bids for each time slot;
allowing users to bid on use of the resource using market and limit orders;
allocating the resource to a highest bidder and canceling alternate time slots;
presenting, to the highest bidder, a display confirming allocation of a time slot, confirming cancellation of alternate time slots, providing a meeting identifier and password, and showing an updated account balance;
updating a network control database with the allocation; and
presenting a display to an out-bid-user that has been out bid indicating that the out-bid-user has been out bid for a time slot and showing a credit to an account balance of the out-bid-user.

12. A method of scheduling a multimedia conference on a network, comprising:
specifying available time slots for use of the network for multimedia conferencing;
defining a plurality of priority levels for access to the time slots during a specified period of time, and a number of available tokens for each priority level;
distributing the tokens to users according to user needs and user command of the resources of the network; and
auctioning the time slots to prospective users using the tokens.

13. A system, comprising:
network resource having time slots; and
a system allocating the resource responsive to bidding on the time slots.

14. A method for managing a network resource, comprising:
assigning a priority to each utilizer of the resource; and
selectively disabling a utilizer having a priority less than a predetermined priority upon selected conditions.

15. A method as recited in claim 14, further comprising allowing a user to upgrade the priority before being disabled.

16. A method as recited in claim 15, wherein the user is notified of the selective disabling via a communication system different from the network resource.

17. A method as recited in claim 14, wherein the priority is assigned on the basis of a status of the user of the resource, a location on the network of the resource, a dependence of other resources on the resource, and an importance of the application.

18. A method as recited in claim 14, wherein the selectively disabling of the utilizer having a priority less than a predetermined priority occurs when a response of the network falls below a predetermined value.

19. A method as recited in claim 14, wherein the selective disabling comprises comparing disabling constraints to a user profile containing priority information regarding applications being run by the user via the resource.

20. A method as recited in claim 19, further comprising issuing local application termination commands responsive to the comparing.

21. A method as recited in claim 14, wherein a portable storage media stores the priority for the resource.

22. A method for managing a multimedia network resource, comprising:
assigning a priority equivalent to a token value to each utilizer of the resource;
selectively disabling a utilizer having a priority less than a predetermined priority by comparing disabling constraints to a user profile containing priority information regarding applications being run by the user via the resource;
notifying the utilizer of the selective disabling via a communication system different from the network resource; and
allowing a user to upgrade the priority before being disabled using tokens for upgrading the priority.

23 A system, comprising:
a multimedia network resource having time slots and users with priority for use; and
a system disabling a user having a priority less than a predetermined priority upon selected conditions using a profile updated by user access of the resource.

24. A method of scheduling and managing utilization of a multimedia conferencing network system, comprising:
allowing users to bid on time slots of the multimedia conferencing network system;
allocating the time slots to the highest bidder using tokens;
assigning a priority to each user of the system based on the token based purchase price of the allocated time slots;
allowing the user to use the system;
selectively disabling a user from using the system when the user has a priority in tokens less than a predetermined priority in tokens upon selected conditions as set by a system administrator; and
allowing the user to increase the priority before disabling the user by bidding a higher price in tokens.

25. A method of resource allocation, comprising:
negotiating an allocation of a limited resource using tokens; and
negotiating continued use of the resource using the tokens when the resource is further limited.

26. A method as recited in claim 25, wherein the negotiating an allocation comprises negotiating allocation of a prior allocation of the resource.

27. A method as recited in claim 25, wherein the negotiating an allocation comprises negotiating an initial allocation of the resource.

28. A method of resource allocation, comprising:
allocating, by a resource administrator, resources to users according to a resource allocation system;
allocating resource tokens to users according to a token allocation system;
allowing users to negotiate the allocation of the resources with the administrator using the tokens;
allowing the users exchange tokens among each other for reallocation for the resources;
auctioning the resources to the users using the tokens; and
allowing the users to negotiate extended use of the resources using the tokens.

29. A method of using a resource, comprising:
negotiating resource use using tokens representing priority; and
managing continued use of the resource by comparing tokens of current uses.

30. A system, comprising:
a network resource having time slots;
a system allocating the resource responsive to bidding on the time slots with tokens; and
a system for disabling a user and allowing the user to upgrade access priority for the resource using the tokens.
